(19) United States
(12) Patent Application Publication
(10) Pub. No.: US 2024/0343193 A1
(43) Pub. Date: Oct. 17, 2024

(54) SVM RECORD AND PLAYBACK DEVICE OF PROVIDING REENACTION OF DRIVE SITUATION

(71) Applicant: Kang San CHOI, Seoul (KR)

(72) Inventor: Kang San CHOI, Seoul (KR)

(21) Appl. No.: 18/519,777

(22) Filed: Nov. 27, 2023

(30) Foreign Application Priority Data
Apr. 15, 2023 (KR) 10-2023-0049701

(51) Int. Cl. B60R 1/22

(52) U.S. Cl. CPC B60R 1/22; B60R 2300/105; B60R 2300/303

(57) ABSTRACT

The present disclosure, in general, relates to a technology of recording and playing a surround view monitoring (SVM) video for a vehicle. In particular, the present disclosure relates to a technology of providing reenaction of drive situation for assisting a user to be able to minutely understand the situation at a specific time point in the past, by recording videos of multi-channel cameras installed on a vehicle for SVM, and providing a SVM environment as in an actual driving after a predetermined time with reenacting a situation around the vehicle at the moment of SVM recording by use of the recorded video files. According to the present disclosure, there is an advantage that a user (e.g., a driver) can minutely know the situation around a vehicle at the moment of an accident because the situation around a vehicle at the moment accident is reenacted in SVM environment.

### BACKGROUND OF THE INVENTION

The present disclosure, in general, relates to a technology of recording and playing a surround view monitoring (SVM) video for a vehicle.

In particular, the present disclosure relates to a technology of providing reenaction of drive situation for assisting a user to be able to minutely understand the situation at a specific time point in the past, by recording videos of multi-channel cameras installed on a vehicle for SVM, and providing a SVM environment as in an actual driving after a predetermined time with reenacting a situation around the vehicle at the moment of SVM recording by use of the recorded video files.

Surround view monitoring (SVM) system for vehicle has been widely spread. The SVM, which is also called around view monitoring (AVM), is a technology of providing a top view or a bird's view by installing cameras on the front, rear, left, and right of a vehicle, capturing the front, rear, left, and right areas of the vehicle, and combining the videos obtained through the cameras. Drivers can exactly know the situation around a vehicle, so driving or parking becomes convenient.

FIG. 1 is a view showing a concept of an SVM technology for a vehicle. Cameras 11 to 14 are mounted on the front and rear and both side mirrors of a vehicle and unit camera videos 15 to 18 are obtained from these multi-channel cameras 11 to 14. The unit camera videos 15 to 18 are made into flat images by applying image enhancement and distortion correction (calibration) and then stitching (image registration and combination) is performed, whereby a surround view video 19 is obtained. The surround view video 19 is provided to the driver through a monitor in the vehicle.

FIG. 2 is an exemplary view of an SVM image. FIG. 2 (a) is a 2D SVM video in which the left one is a rear camera video and the right one is a bird's eye view (top view) video. In the 2D SVM video, two adjacent camera videos are shown translucently overlapped in the boundary combination regions between the videos by the front and rear camera videos 15 and 16 and both side camera videos 17 and 18. FIG. 2 (b) is a 3D SVM video, in which the 3D SVM video provides a combination video in a 3D viewpoint, thereby enabling the driver to know the situation around the vehicle. When a user touches the monitor videos of FIG. 2 (a) and (b), it is possible to see the situation around the vehicle while changing the viewpoint.

SVM devices may provide a function of recording unit camera videos 15 to 18 created by the multi-channel cameras 11 to 14 and playing the videos later. FIG. 3 is an exemplary view of playback images of recorded videos that are provided by an SVM device of the related art. In general, videos distorted by wide angle cameras are played as it is, as shown in FIG. 3. Further, an SVM device may provide a function of recording a surround view video 19 and playing the surround view video 19 later. A surround view video 19 provided to a user through a monitor in a vehicle is recorded as it is and played.

The SVM technology is applied for preventing car accidents during driving. Further, the SVM technology is applied for securing evidences when an accident occurs. It is required to expand the SVM technology.

### SUMMARY OF THE INVENTION

An objective of the present disclosure is to provide a technology of recording and playing a surround view monitoring (SVM) video for a vehicle.

In particular, an objective of the present disclosure is to provide a technology of providing reenaction of drive situation for assisting a user to be able to minutely understand the situation at a specific time point in the past, by recording videos of multi-channel cameras installed on a vehicle for SVM, and providing a SVM environment as in an actual driving after a predetermined time with reenacting a situation around the vehicle at the moment of SVM recording by use of the recorded video files.

In order to achieve the objectives described above, an SVM record and playback device of providing reenaction of drive situation according to an embodiment of the present disclosure may include: a video input unit 110 receiving a plurality of unit camera videos 15 to 18 from multi-channel cameras 11 to 14 installed on a vehicle for surround view monitoring (SVM); an SVM combination unit 120 provided with the plurality of unit camera videos 15 to 18 from the video input unit 110 and creating an SVM video by combining the videos; a video playback unit 130 playing and displaying the SVM video; a video encoding unit 140 creating multi-channel camera videos 35 to 38 by encoding the unit camera videos 15 to 18 received by the video input unit 110; a memory storage unit 150 temporarily storing the multi-channel camera videos 35 to 38 created by the video encoding unit 140; a file storage unit 160 reading out the multi-channel camera videos 35 to 38 temporarily stored in the memory storage unit 150 and storing the multi-channel camera videos as a series of video files in chronological order; a video decoding unit 170 creating multi-channel video streams 41 to 44 by decoding some of the series of video files stored in the file storage unit 160; a camera input conversion unit 180 converting the multi-channel streams 41 to 44 created by the video decoding unit 170 into a plurality of unit camera videos 45 to 48 for SVM combination and then inserting the videos into a transmission channel of the plurality of unit camera videos 15 to 18 that goes from the video input unit 110 to the SVM combination unit 120.

### BRIEF DESCRIPTION OF THE DRAWINGS

FIG. 1 is a view showing a concept of a surround view monitoring (SVM) technology for a vehicle;

FIG. 2 is an exemplary view of an SVM image;

FIG. 3 is an exemplary view of playback images of SVM recorded videos of the related art;

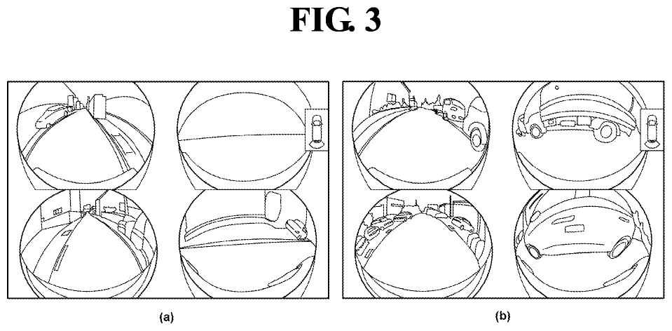

FIG. 4 is a block diagram of an SVM record and playback device of providing reenaction of drive situation according to a first embodiment of the present disclosure;

FIG. 5 is a block diagram of an SVM record and playback device of providing reenaction of drive situation according to a second embodiment of the present disclosure;

FIG. 6 is an exemplary view of playback images of 2D SVM recorded videos by the present disclosure;

FIG. 7 is an exemplary view of playback images of 3D SVM recorded videos by the present disclosure; and

FIG. 8 is an exemplary view of playback images of 3D SVM recorded videos by the present disclosure.

### DESCRIPTION OF SPECIFIC EMBODIMENTS

The present disclosure is described hereafter in detail with reference to the accompanying drawings.

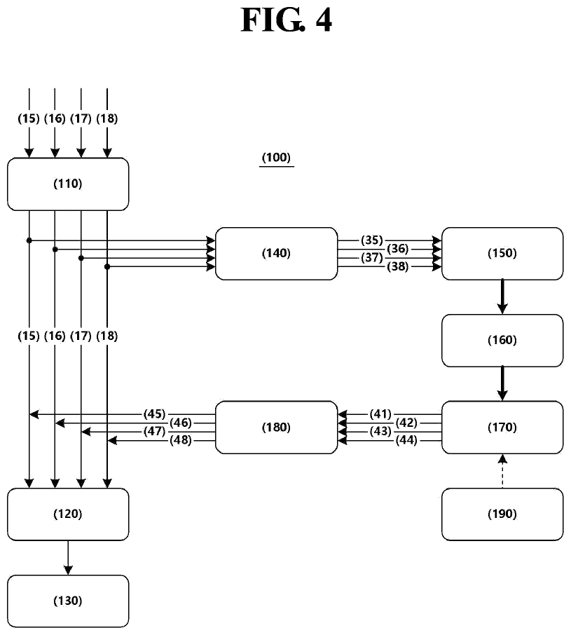

FIG. 4 is a block diagram of an SVM record and playback device 100 providing reenaction of drive situation according to a first embodiment of the present disclosure.

An SVM record and playback device according to the present disclosure is characterized, in addition to providing a surround view monitoring (SVM) function using multi-channel cameras 11 to 14 installed on a vehicle, by recording a plurality of unit camera videos 15 to 18 obtained from the multi-channel cameras 11˜14 as video files in a storage space and providing an SVM environment that is the same as actual driving using the recorded video files.

Accordingly, the situation around the vehicle at the moment of SVM recording is reenacted and played the same as the actual driving through SVM, thereby assisting a user to be able to minutely understand the situation at a specific time point in the past. As an embodiment, a user can minutely see the surrounding of a vehicle through an SVM image. Further, a user can closely see the surrounding of a vehicle at various angles by turning a viewpoint 360 degrees through touch operation.

Referring to FIG. 4, the SVM record and playback device of providing reenaction of drive situation according to the present disclosure include a video input unit 110, an SVM combination unit 120, a video playback unit 130, a video encoding unit 140, a memory storage unit 150, a file storage unit 160, a video decoding unit 170, a camera input conversion unit 180, and a situation reenaction control unit 190.

The video input unit 110 is a component that receives a plurality of unit camera videos 15 to 18 obtained from multi-channel cameras 11 to 14 installed on a vehicle for SVM. The video input unit 110 transmits the unit camera videos 15 to 18 in the form of a plurality of videos or in the form of one combined video to the video encoding unit 140.

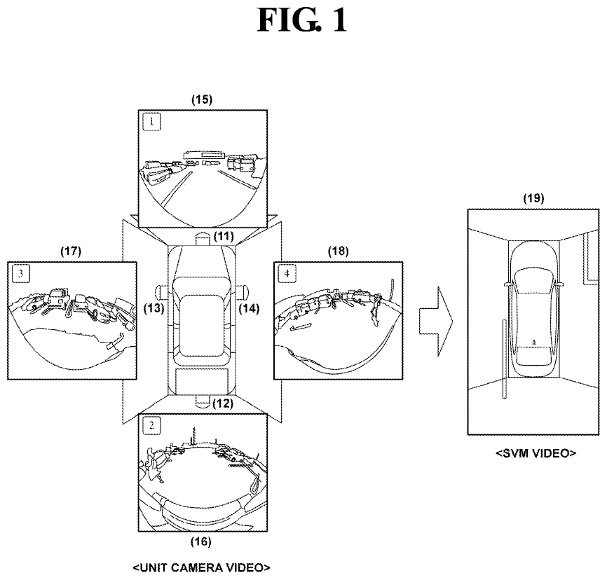

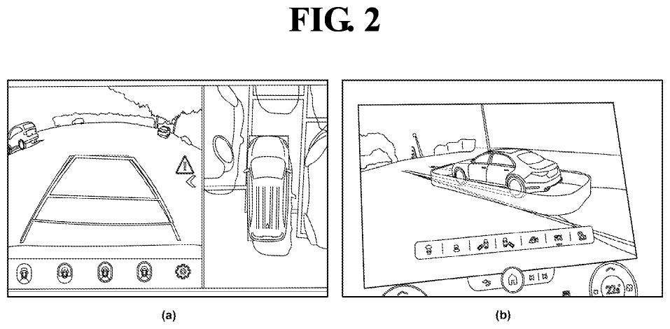

The SVM combination unit 120 is a component that is provided with the plurality of unit camera videos 15 to 18 from the video input unit 110 and creates an SVM video by combining the videos. For example, as described above with reference to FIG. 1 and FIG. 2, image enhancement, distortion correction, and stitching are performed on the plurality of unit camera videos 15 to 18, whereby 2D SVM videos or 3D SVM videos are created. To this end, the SVM combination unit 120 stores a setting value (parameter value) for SVM registration. In this case, as described above with reference to FIG. 2, the SVM combination unit 120 can configure an SVM image while changing the viewpoint in response to operation by a user.

The video playback unit 130 is a component that plays and displays an SVM video created by the SVM combination unit 120.

The video encoding unit 140 is a component that creates multi-channel camera videos 35 to 38 by encoding the unit camera videos 15 to 18 received by the video input unit 110. The multi-channel camera videos 35 to 38 may be in the form of a plurality of videos or the form of one combined video.

The memory storage unit 150 is a component that temporarily stores the multi-channel camera videos 35 to 38 created by the video encoding unit 140. The memory storage unit 150 can function as a memory buffer for solving a data processing timing difference between the video encoding unit 140 and the file storage unit 160.

The file storage unit 160 is a component that reads out the multi-channel camera videos 35 to 38 temporarily stored in the memory storage unit 150 and stores them as a series of video files in chronological order (e.g., one video file per 30 seconds).

The video decoding unit 170 is a component that creates multi-channel video streams 41 to 44 by decoding some of the series of video files stored in the file storage unit 160. The operation of the video decoding unit 170 decoding the video files stored in the file storage unit 160 is an operation that is performed when the SVM record and playback device 100 intends to reenact a past drive situation. In this case, which video file of the series of video files stored in the file storage unit 160 the video decoding unit 170 selects as an object of decoding corresponds to the reenaction time point that a user want to see.

The situation reenaction control unit 190 is a component that controls selection of video files to be decoded by the video decoding unit 170 in correspondence to touch operation (e.g., rewind, stop, fast forward, click a specific point) by a user adjusting a drive situation reenaction time point.

The camera input conversion unit 180 is a component that converts the multi-channel streams 41 to 44 created by the video decoding unit 170 into a plurality of unit camera videos 45 to 48 for SVM combination and then inserts the videos into a transmission channel of a plurality of unit camera videos 15 to 18 that goes from the video input unit 110 to the SVM combination unit 120. Accordingly, the SVM combination unit 120 receives the plurality of unit camera videos 45 to 48 from the camera input conversion unit 180 in the same format as when the unit camera videos 15 to 18 are input from the video input unit 110. Therefore, an SVM video is created by combining the unit camera videos 45 to 48 in a similar manner of creating an SVM video by combining the unit camera videos 15 to 18.

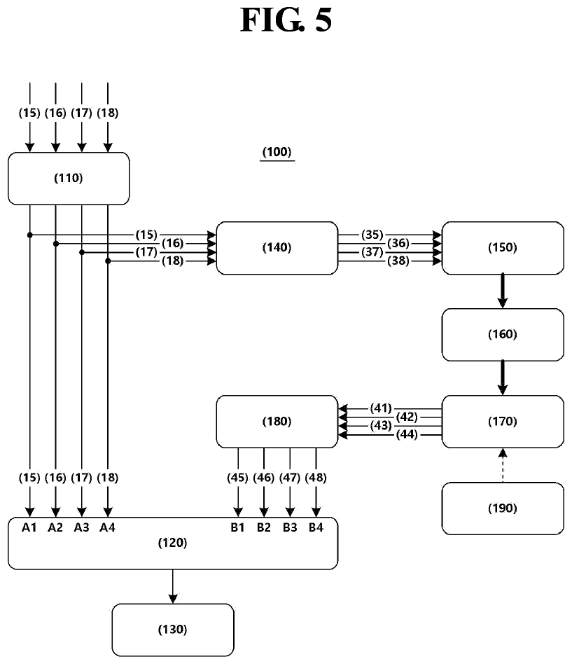

FIG. 5 is a block diagram of an SVM record and playback device 100 providing reenaction of drive situation according to a second embodiment of the present disclosure.

Comparing with the first embodiment of FIG. 4, the second embodiment of FIG. 5 has a difference in that the SVM combination unit 120 has two input channels A1 to A4 and B1 to B4, so a plurality of unit camera videos 15 to 18 is provided from the video input unit 110 through the first input channel A1 to A4 and a plurality of unit camera videos 45 to 48 is provided from the camera input conversion unit 180 through the second input channels B1 to B4.

The SVM combination unit 120 selects any one of the two input channels A1 to A4 and B1 to B4 depending on whether a user wants a current SVM video or an SVM video for reenacting a past drive situation, and creates an SVM video by combining a plurality of unit camera videos 15 to 18 or 45 to 48 that is input through the selected input channel.

The present disclosure can achieve the following advantages through the technical configuration described above.

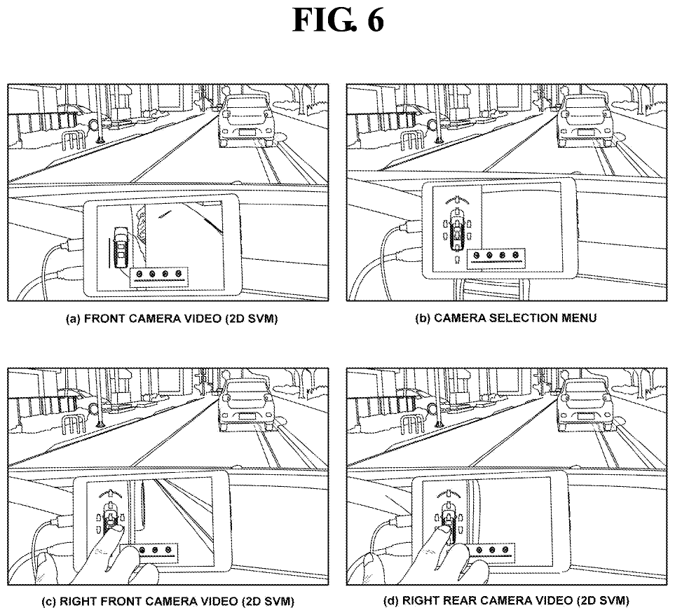

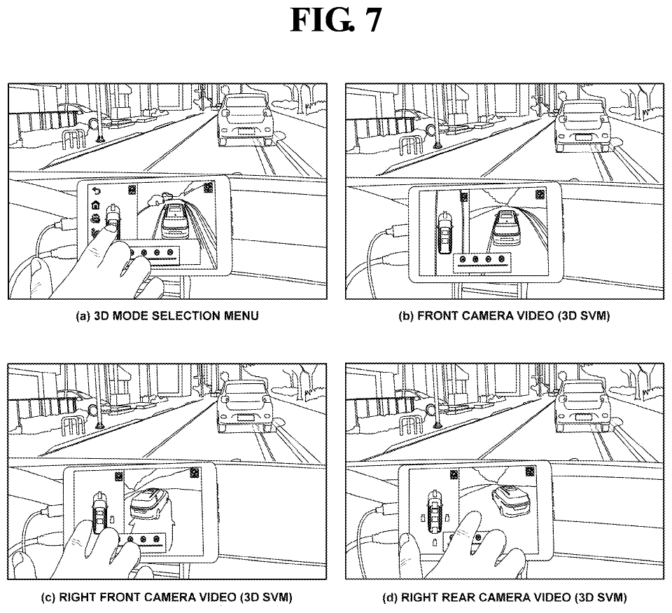

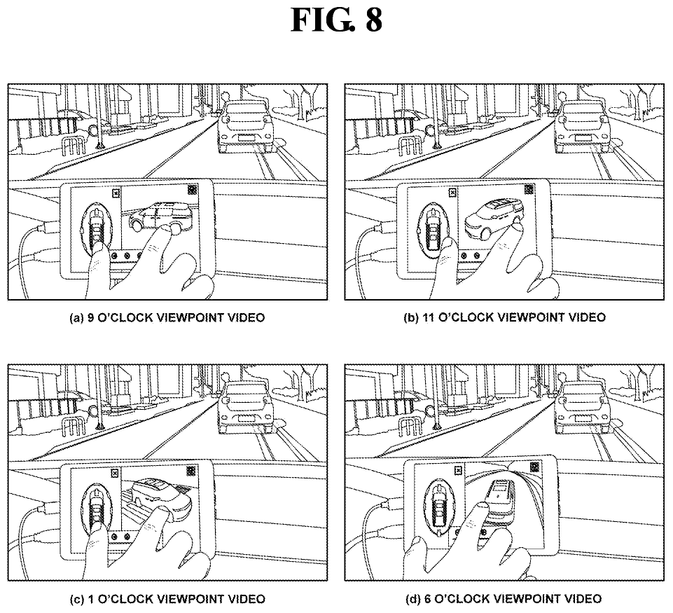

First, using an SVM algorithm, it is possible to reenact the surrounding video of a past drive situation recorded in a storage into a top view like seeing from the sky, a 3D view like actually seeing the surrounding of a vehicle, and camera views divided into front/rear/left/right. FIGS. 6 to 8 exemplify playback images of SVM recorded videos of various past drive situations that a user can see by the present disclosure. It is possible to know that it is a reenaction video of a past drive situation in that the SVM videos displayed on a monitor in a vehicle are totally different from the current situation seen through the windshield of the vehicle.

Second, a user can reenact and play a surrounding situation around blind spots and at time points at which SVM videos were recorded by distorting and converting videos in several various view modes that make it intuitive and easy to distinguish the contents of videos.

Third, it is possible to play the situation at the moment of recording a video as a combined 3D video at various angles and in a top view state by variously changing views and finely adjusting an angle in a 3D view with the video stopped during playing. Fourth, it is possible to store and play even a predetermined elapsed time (30 seconds) into a 3D view even after the moment that a user wants to store during driving is past.

Fifth, it is possible to freely correct and combine videos so that the videos are seen without distortion even through a wide angle camera for SVM.

According to the present disclosure, there is an advantage that a user (e.g., a driver) can minutely understand the situation around a vehicle at the moment of an accident because the situation around a vehicle at the moment accident is reenacted in SVM environment.

While the present invention has been described with respect to the specific embodiments, it will be apparent to those skilled in the art that various changes and modifications may be made without departing from the spirit and scope of the invention as defined in the following claims.

What is claimed is:

1. An SVM record and playback device of providing reenaction of drive situation, the SVM record and playback device comprising:
a video input unit receiving a plurality of unit camera videos from multi-channel cameras installed on a vehicle for surround view monitoring (SVM);
an SVM combination unit provided with the plurality of unit camera videos from the video input unit and creating an SVM video by combining the videos;
a video playback unit playing and displaying the SVM video;
a video encoding unit creating multi-channel camera videos by encoding the unit camera videos received by the video input unit;
a memory storage unit temporarily storing the multi-channel camera videos created by the video encoding unit;
a file storage unit reading out the multi-channel camera videos temporarily stored in the memory storage unit and storing the multi-channel camera videos as a series of video files in chronological order;
a video decoding unit creating multi-channel video streams by decoding some of the series of video files stored in the file storage unit; and
a camera input conversion unit converting the multi-channel streams created by the video decoding unit into a plurality of unit camera videos for SVM combination and then inserting the videos into a transmission channel of the plurality of unit camera videos that goes from the video input unit to the SVM combination unit.

2. The SVM record and playback device of claim 1, further comprising:
a situation reenaction control unit controlling selection of video files to be decoded by the video decoding unit in correspondence to touch operation by a user adjusting a drive situation reenaction time point.

3. An SVM record and playback device of providing reenaction of drive situation, the SVM record and playback device comprising:
a video input unit receiving a plurality of unit camera videos from multi-channel cameras installed on a vehicle for surround view monitoring (SVM);
a video encoding unit creating multi-channel camera videos by encoding the unit camera videos received by the video input unit;
a memory storage unit temporarily storing the multi-channel camera videos created by the video encoding unit;
a file storage unit reading out the multi-channel camera videos temporarily stored in the memory storage unit and storing the multi-channel camera videos as a series of video files in chronological order;
a video decoding unit creating multi-channel video streams by decoding some of the series of video files stored in the file storage unit;
a camera input conversion unit converting and outputting the multi-channel streams created by the video decoding unit into a plurality of unit camera videos for SVM combination;
an SVM combination unit being provided with a plurality of unit camera videos from the video input unit through a first input channel, being provided with a plurality of unit camera videos from the camera input conversion unit, and creating an SVM video by selecting any one input channel in response to operation by a user and combining videos; and
a video playback unit playing and displaying the SVM video.

4. The SVM record and playback device of claim 3, further comprising:
a situation reenaction control unit controlling selection of video files to be decoded by the video decoding unit in correspondence to touch operation by a user adjusting a drive situation reenaction viewpoint.
